(19) United States
(12) Patent Application Publication
(10) Pub. No.: US 2025/0020916 A1
(43) Pub. Date: Jan. 16, 2025

(54) OPTICAL SYSTEM AND HEAD-UP DISPLAY SYSTEM INCLUDING SAME

(71) Applicant: Panasonic Intellectual Property Management Co., Ltd., Osaka (JP)

(72) Inventors: Akira HASHIYA, Osaka (JP); Satoshi Kuzuhara, Osaka (JP)

(21) Appl. No.: 18/899,123

(22) Filed: Sep. 27, 2024

Related U.S. Application Data
(63) Continuation of application No. PCT/JP2023/001538, filed on Jan. 19, 2023.

(30) Foreign Application Priority Data
Mar. 31, 2022 (JP) 2022-060576

(51) Int. Cl. G02B 27/00; B60K 35/23; G02B 27/01; G02B 27/10

(52) U.S. Cl. CPC G02B 27/0081; B60K 35/23; G02B 27/0172; G02B 27/106; G02B 27/1086; B60K 2360/23; B60K 2360/785

(57) ABSTRACT

An optical system includes a first expansion region that expands a luminous flux traveling in a first direction by splitting and duplicating it into luminous fluxes traveling in a second direction intersecting the first direction to increase the number of luminous fluxes, and a second expansion region that expands the luminous fluxes traveling in the second direction by splitting and duplicating them to increase the number of luminous fluxes. The first expansion region has a central region that contains a center of the first expansion region, and an end region that lies on at least one end side of the first expansion region. The end region has a diffracted light quantity less than half the diffracted light quantity in the central region.

### CROSS-REFERENCE TO RELATED APPLICATIONS

This is a continuation application of International Application No.PCT/JP2023/001538, with an international filing date of Jan. 19, 2023, which claims priority of Japanese Patent Application No. 2022-060576 filed on Mar. 31, 2022, the content of which is incorporated herein by reference.

### BACKGROUND

### Technical Field

The present disclosure relates to an optical system used for displaying an image, and a head-up display system including the same.

### Background Art

Up until now, a vehicle information projection system has been disclosed that uses a head-up display to perform augmented reality (AR) display. The head-up display system, for example, projects light representing a virtual image onto a vehicle windshield, allowing the driver to view the virtual image along with the real scene outside the vehicle.

U.S. Pat. No. 10,429,645 describes, as a device for displaying a virtual image, an optical system having a waveguide (light guide) for expanding an exit pupil in two directions. The optical system is capable of expanding the exit pupil by using a diffractive optical element. U.S. Patent Application Pub. No. 2009/0097122 describes a head-mounted display that keeps constant the quantity of light diffracted from a diffraction grating by modulating the height and duty ratio of the diffraction grating.

### SUMMARY

However, if there is angular variation in the luminous fluxes incident on the optical system that expands an exit pupil, the image emerging from the optical system is partially missing. Also, there is a demand for displaying images with higher luminance.

The present disclosure provides an optical system and a head-up display system that prevent an image from being partially missing and improve the efficiency of utilization of luminous fluxes.

The optical system of the present disclosure is an optical system for allowing an observer to visually recognize an image, including: a first expansion region that expands a luminous flux traveling in a first direction by splitting and duplicating it into luminous fluxes traveling in a second direction intersecting the first direction to increase the number of luminous fluxes; and a second expansion region that expands the luminous fluxes traveling in the second direction by splitting and duplicating them to increase the number of luminous fluxes, the first expansion region having a central region that contains a center of the first expansion region, and an end region that lies on at least one end side of the first expansion region, the end region having a diffracted light quantity less than half the diffracted light quantity in the central region.

The head-up display system of the present disclosure includes: the above optical system; a display part that emits a luminous flux before being expanded by the optical system; and a light-transmitting member that reflects a luminous flux emitted from the optical system, the image as a virtual image being displayed superimposed on a real scene visible through the light-transmitting member.

According to the optical system and the head-up display system of the present disclosure, an optical system and a head-up display system can be provided that prevent an image from being partially missing and improve the efficiency of utilization of luminous fluxes.

### BRIEF DESCRIPTION OF THE DRAWINGS

FIG. 1 is a schematic perspective view showing the configuration of a light guide.

FIG. 2 is an explanatory view showing the directions of incident light and emitted light to a light guide of a head-mounted display.

FIG. 3 is an explanatory view showing the directions of incident light and emitted light to a light guide of a head-up display.

FIG. 4 is a cross-sectional view taken along a Y1-Z1 plane of a vehicle equipped with a head-up display system of an embodiment.

FIG. 5 is an explanatory view showing an optical path of a luminous flux emitted from a display part.

FIG. 6 is a transparent perspective view showing a configuration of the light guide according to an embodiment.

FIG. 7A-7B are explanatory views showing a central optical path of a luminous flux emitted from the display part.

FIG. 8A-8B are explanatory views showing optical paths of luminous fluxes traveling through a first expansion region and a second expansion region.

FIG. 9A-9B are explanatory views showing the optical paths of luminous fluxes traveling through a first expansion region and a second expansion region in a modification.

FIG. 10 is a graph showing the transition of the proportion of the quantity of light diffracted when modulation of the diffraction efficiency is not performed in a comparative example.

FIG. 11 is a graph showing the modulation of the diffraction efficiency performed so that the transition of the proportion of the quantity of light diffracted becomes constant in a comparative example.

FIG. 12 is a graph showing the modulation of the diffraction efficiency of the first expansion region and the transition of the proportion of the quantity of light diffracted in the embodiment.

FIG. 13 is a longitudinal cross-sectional view of a diffraction grating disposed in the first expansion region in the embodiment.

FIG. 14 is a longitudinal cross-sectional view of a diffraction grating disposed in the first expansion region in the embodiment.

FIG. 15A-15B are explanatory views showing optical paths of luminous fluxes traveling through a first expansion region and a second expansion region of a light guide in a first modification of the embodiment.

FIG. 16 is a graph showing the modulation of the diffraction efficiency of the first expansion region and the transition of the proportion of the quantity of light diffracted in the first modification of the embodiment.

FIG. 17A-17B are explanatory views showing optical paths of luminous fluxes traveling through a first expansion region and a second expansion region of a light guide in a second modification of the embodiment.

FIG. 18 is a graph showing the modulation of the diffraction efficiency of the first expansion region and the transition of the proportion of the quantity of light diffracted in the second modification of the embodiment.

FIG. 19A-19B are explanatory views showing optical paths of luminous fluxes traveling through a first expansion region and a second expansion region of a light guide in a third modification of the embodiment.

FIG. 20 is a graph showing the modulation of the diffraction efficiency of the first expansion region and the transition of the proportion of the quantity of light diffracted in the third modification of the embodiment.

FIG. 21A-21B are explanatory views showing optical paths of luminous fluxes traveling through a first expansion region and a second expansion region of a light guide in a fourth modification of the embodiment.

FIG. 22 is a graph showing the modulation of the diffraction efficiency of the first expansion region and transition of the proportion of the quantity of light diffracted in the fourth modification of the embodiment.

FIG. 23A-23B are explanatory views showing optical paths of luminous fluxes traveling through a first expansion region and a second expansion region of a light guide in a fifth modification of the embodiment.

FIG. 24 is a graph showing the modulation of the diffraction efficiency of the first expansion region and the transition of the proportion of the quantity of light diffracted in the fifth modification of the embodiment.

### DETAILED DESCRIPTION

### (Overview of the Disclosure)

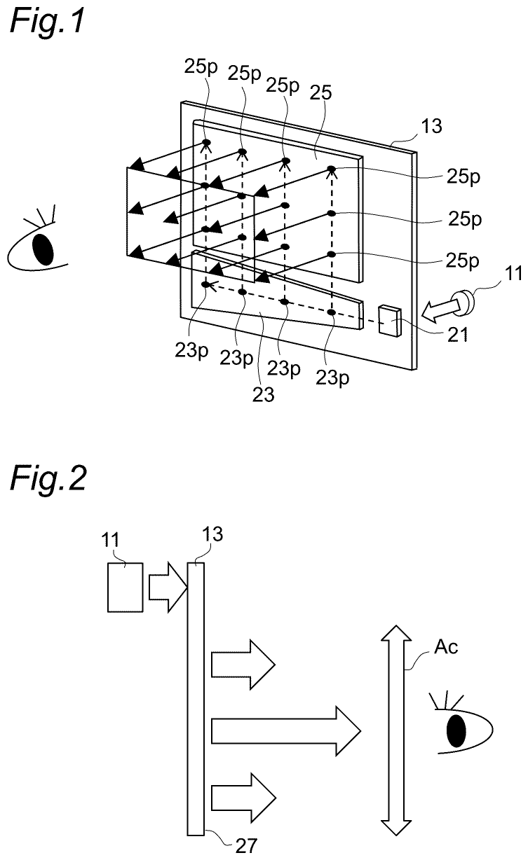

Referring to FIG. 1, an overview of the present disclosure will first be described. FIG. 1 is a schematic view showing the configuration of a light guide 13. A so-called pupil expansion type light guide 13 is used in an optical system for use in a head-mounted display (hereinafter, referred to as HMD) or the like. The pupil expansion type light guide 13 includes a coupling region 21 that receives image light from a display part 11 to change the traveling direction thereof, a first expansion region 23 that expands the image light in a first direction, and a second expansion region 25 that expands the image light in a second direction. The first direction and the second direction may intersect with each other, for example, they may be orthogonal to each other.

The coupling region 21, the first expansion region 23, and the second expansion region 25 each have a diffraction power for diffracting the image light and are formed with a diffractive structure element such as an embossed hologram or a volume hologram. The embossed hologram is, for example, a diffraction grating. The volume hologram is, for example, a periodic refractive index distribution in a dielectric film. The coupling region 21 changes the traveling direction of the image light incident from the outside toward the first expansion region 23 by the diffraction power.

The first expansion region 23 is arranged with, for example, a diffractive structure element, which duplicates the image light by splitting the incident image light into image light traveling in the first direction and image light traveling to the second expansion region 25 by the diffraction power. For example, in FIG. 1, the first expansion region 23 has diffractive structure elements arranged at four points 23p that are aligned in the direction in which the image light travels with repeated total reflection. The diffractive structure element splits the image light at each point 23p to allow the split image light to travel to the second expansion region 25. As a result, a luminous flux of the incident image light is expanded by being duplicated into four luminous fluxes of the image light in the first direction. As a result, the luminous flux of the incident image light is duplicated in the first direction into four luminous fluxes of image light, thereby being expanded.

The second expansion region 25 has, for example, a diffractive structure element arranged therein, which duplicates the image light by splitting the incident image light into image light traveling in the second direction and image light emitted from the second expansion region 25 to the outside. For example, in FIG. 1, three points 25p are arranged per row in the direction where the image light travels with repeated total reflection in the second expansion region 25, the diffractive structure element being disposed at each of a total of 12 points 25p in four rows. The image light is split at each point 25p, and the split image light is emitted to the outside. As a result, the luminous fluxes of the image light incident in the four rows are each expanded by being duplicated into three luminous fluxes of the image luminous fluxes in the second direction. In this way, the light guide 13 can duplicate 12 luminous fluxes of the image light from one incident luminous flux of the image light and expand the visual recognition area by duplicating the luminous fluxes in the first direction and the second direction. The observer can visually recognize each of the twelve luminous fluxes of the image light as a virtual image, and the visual recognition area where the observer can visually recognize the image light can be widened.

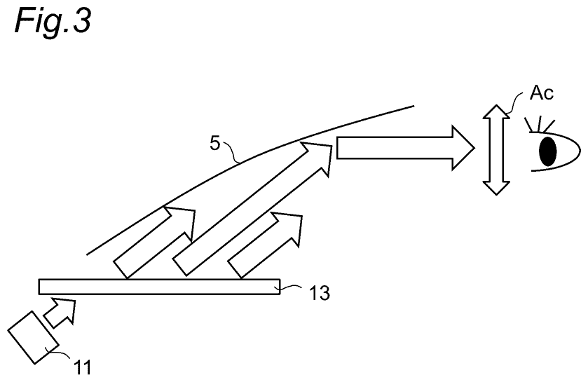

Referring then to FIGS. 2 and 3, the difference between a pupil expansion type HMD and a head-up display (hereinafter referred to as HUD) will be described. FIG. 2 is an explanatory view showing incident light and emitted light of an HMD. FIG. 3 is an explanatory view showing incident light and emitted light of an HUD.

As shown in FIG. 2, the light guide 13 in the HMD faces substantially directly toward a visual recognition area Ac where an observer can visually recognize a virtual image. Image light perpendicularly incident from the display part 11 is split within the light guide 13, and the split image light is emitted perpendicularly from an emission surface 27 of the light guide 13 toward the visual recognition area Ac.

In contrast, as shown in FIG. 3, in the case of an HUD, the image light emitted from the light guide 13 is reflected by, for example, a windshield 5 and enters the visual recognition area Ac, so that the split image light is emitted in an oblique direction from the emission surface 27 of the light guide. An optical system for the HUD will be described below.

### Embodiment

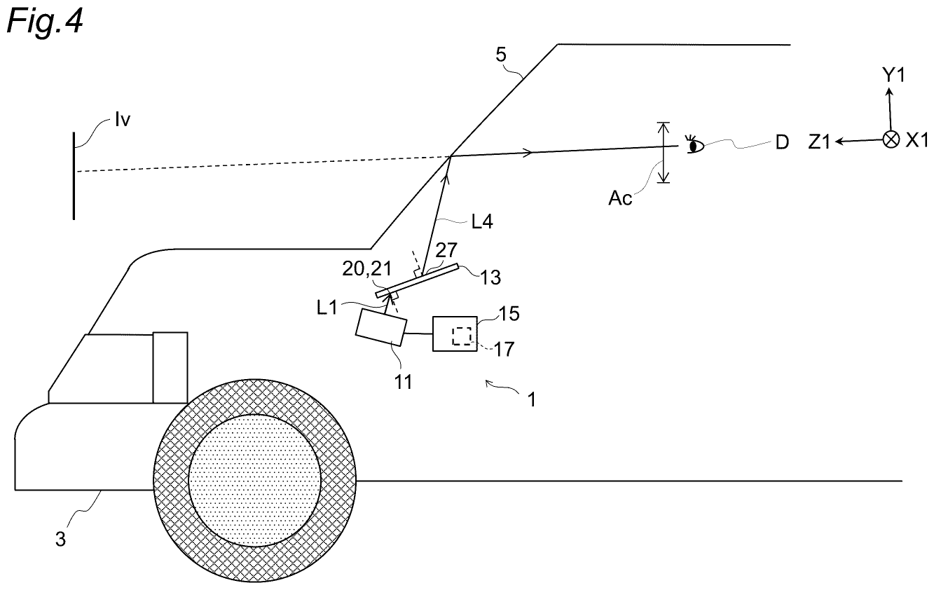

An embodiment will now be described with reference to FIGS. 4 to 6. Note that constituent elements having functions common to those of the above constituent elements are given the same reference numerals. The tilt angles of the windshield in the figures are shown for ease of understanding, and may differ from figure to figure.

### [1-1. Configuration]

### [1-1-1. Overall Configuration of Optical System and Head-Up Display System]

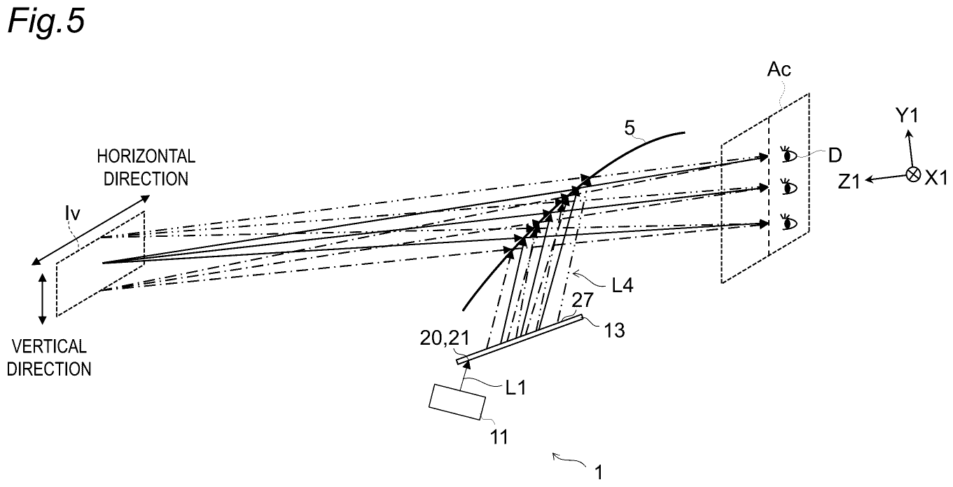

A specific embodiment of a head-up display system 1 (hereinafter referred to as HUD system 1) of the present disclosure will be described. FIG. 4 is a view showing a cross-section of a vehicle 3 equipped with the HUD system 1 according to the present disclosure. FIG. 5 is an explanatory view showing an optical path of a luminous flux emitted from a display part. In the embodiment, the HUD system 1 equipped in the vehicle 3 will be described as an example.

In the following, the directions related to the HUD system 1 will be described based on X1, Y1, and Z1 axes shown in FIG. 4. The Z1-axis direction is a direction in which the observer visually recognizes a virtual image Iv from the visual recognition area Ac where the observer can visually recognize the virtual image Iv. The X1-axis direction is a horizontal direction orthogonal to the Z1-axis. The Y1-axis direction is a direction orthogonal to an X1-Z1 plane formed by the X1 and Z1 axes. Hence, the X1-axis direction corresponds to a horizontal direction of the vehicle 3, the Y1-axis direction corresponds to a substantially vertical direction of the vehicle 3, and the Z1-axis direction corresponds to a substantially forward direction of the vehicle 3.

As shown in FIG. 4, the display part 11 and the light guide 13 are arranged inside a dashboard (not shown) below the windshield 5 of the vehicle 3. The observer D sitting in the driver's seat of the vehicle 3 recognizes an image projected from the HUD system 1 as a virtual image Iv. In this way, the HUD system 1 displays the virtual image Iv superimposed on a real scene visible through the windshield 5. Since a plurality of duplicated images are projected onto the visual recognition area Ac, the virtual image Iv can be seen as long as it lies within the visual recognition area Ac even if the observer D's eye position is shifted in the Y-axis and X-axis directions. The observer D is a person on board who rides in a moving object such as the vehicle 3, for example, a driver or a passenger who sits on the front passenger seat.

Reference is made to FIG. 4. The HUD system 1 includes the display part 11, the light guide 13, a controller 15, and the windshield 5. The display part 11 emits a luminous flux L1 that forms an image that is visually recognized by the observer as a virtual image Iv. The light guide 13 splits and duplicates a luminous flux L1 emitted from the display part 11 and guides a duplicated luminous flux L4 to the windshield 5. The luminous flux L4 reflected by the windshield 5 is displayed as a virtual image Iv superimposed on a real scene visible through the windshield 5.

The display part 11 emits a luminous flux before being expanded by the light guide 13 and displays an image, for example, based on control by an external controller. For example, a backlit liquid crystal display (LCD), an organic light-emitting diode (OLED) display, a plasma display, or the like can be used as the display part 11. The display part 11 may generate an image using a screen that diffuses or reflects light and a projector or a scanning laser. The display part 11 can show image content including various pieces of information such as a road progress guidance indication, a distance to a precedent vehicle, a remaining battery level of a vehicle, and a current vehicle velocity. In this way, the display part 11 emits a luminous flux L1 containing image content that is visually recognized as a virtual image Iv by the observer D.

The controller 15 can be implemented by a circuit composed of semiconductor elements, etc. The controller 15 can be configured by, for example, a microcomputer, a CPU, an MPU, a GPU, a DSP, an FPGA, or an ASIC. The controller 15 implements a predefined function by reading data or a program stored in a built-in storage 17 and performing various arithmetic processes. The storage 17 is a storage medium that stores programs and data necessary to implement the functions of the controller 15. The storage 17 can be implemented by, for example, a hard disk (HDD), an SSD, a RAM, a DRAM, a ferroelectric memory, a flash memory, a magnetic disk, or a combination thereof. The storage 17 further stores plural pieces of image data representing a virtual image Iv. The controller 15 determines a virtual image Iv to be displayed based on vehicle-related information acquired from the outside. The controller 15 reads image data of the determined virtual image Iv from the storage and outputs it to the display part 11.

### [1-1-2. Light Guide]

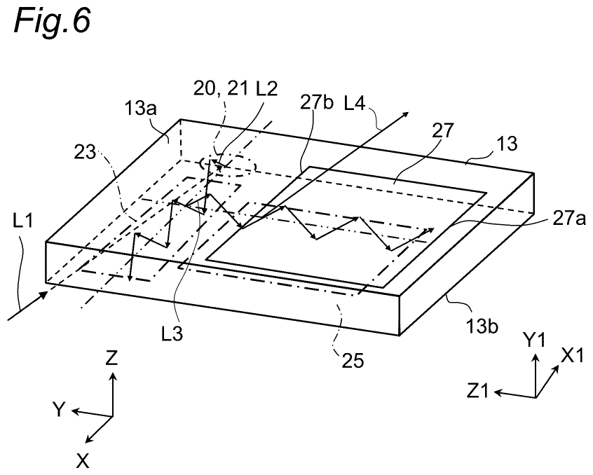

Referring to FIG. 6, the configuration of the light guide 13 will be described. FIG. 6 is a perspective view showing a configuration of the light guide 13. The directions of the expansion regions of the light guide 13 will be described below based on X, Y, and Z axes shown in FIG. 6. The normal direction to the surface of the light guide 13 at the center or the center of gravity of the first expansion region 23 is defined as the Z-axis direction, and the tangential plane thereat is defined as an X-Y plane. In the X-Y plane, the direction of travel of a central ray of the luminous flux entering the first expansion region from the coupling region is defined as the X-axis direction, and the direction perpendicular to the X-axis direction is defined as the Y-axis direction.

The light guide 13 has a first main surface 13a and a second main surface 13b, which are surfaces. The first main surface 13a and the second main surface 13b face each other. The light guide 13 has an incidence surface 20, the coupling region 21, the first expansion region 23, a second expansion region 25, and the emission surface 27. The incidence surface 20, the coupling region 21, the first expansion region 23, and the second expansion region 25 are included in the second main surface 13b, while the emission surface 27 is included in the first main surface 13a. the first expansion region 23 and the second expansion region 25 are therefore arranged on the same plane.

The emission surface 27 faces the second expansion region 25. The coupling region 21, the first expansion region 23, and the second expansion region 25 may lie between the first and second main surfaces 13a and 13b. The first main surface 13a faces the windshield 5. In this embodiment, the incidence surface 20 is included in the coupling region 21, but it may be a surface facing the coupling region 21 and included in the first main surface 13a. The emission surface 27 may be included in the second expansion region 25.

The coupling region 21, the first expansion region 23, and the second expansion region 25 each have a different diffraction power and each have a diffractive structure element formed therein. The coupling region 21, the first expansion region 23, and the second expansion region 25 each have a different diffraction angle of the image light. The light guide 13 is configured such that the incident luminous flux is totally reflected inside. In this manner, the light guide 13 includes a diffractive structure element, such as, for example, a volume hologram, that diffracts light in a part of it. The coupling region 21, the first expansion region 23, and the second expansion region 25 are three-dimensional regions when they contain the volume holograms.

The coupling region 21 is a region that receives through the incidence surface 20 the luminous flux L1 emitted from the display part 11 and changes the direction of travel of the luminous flux L1. The coupling region 21 has a diffraction power and changes the direction of propagation of the incident luminous flux L1 to the direction toward the first expansion region 23, for emission as a luminous flux L2. In this embodiment, coupling refers to a state of propagating in the light guide 13 under a total reflection condition.

The first expansion region 23 expands the luminous flux L2 in a first direction corresponding to the horizontal direction of the virtual image Iv and emits the luminous flux L2 to the second expansion region in a second direction (−Y-axis direction) intersecting the first direction (X-axis direction). In the first expansion region 23 that expands the luminous flux L2 in the first direction, the length in the first direction is greater than the length in the second direction. In the embodiment, the light guide 13 is arranged so that the first direction is the horizontal direction (the direction of the X1 axis), but this is not limitative, and the first direction need not completely coincide with the horizontal direction. The luminous flux L2 propagated from the coupling region 21 propagates in the first direction while repeating total reflection at the first main surface 13a and the second main surface 13b and is duplicated by the diffractive structure of the first expansion region 23 formed on the second main surface 13b to be emitted to the second expansion region 25.

The second expansion region 25 expands a luminous flux L3 in a second direction corresponding to the vertical direction of the virtual image Iv and emits the expanded luminous flux L4 from the emission surface 27. The second direction is, for example, perpendicular to the first direction. The light guide 13 is disposed such that the second direction is in the Z1-axis direction. The luminous flux L3 propagated from the first expansion region 23 propagates in the second direction while repeating total reflection at the first main surface 13a and the second main surface 13b and is duplicated by the diffractive structure of the second expansion region 25 formed on the second main surface 13b to be emitted via the emission surface 27 to the outside of the light guide 13.

Consequently, from the viewpoint of the observer D, the light guide 13 expands the luminous flux L1, which has been incident on the incidence surface 20 and has had its direction of travel changed, in the horizontal direction (the direction of the X1 axis) of the virtual image Iv visually recognized by the observer D and then further expands it in the vertical direction (the direction of the Y1 axis) of the virtual image Iv to emit the luminous flux L4 from the emission surface 27. In this case, duplication in the horizontal direction of the image is not limited to duplication in the completely horizontal direction only, but also includes duplication in the substantially horizontal direction. Duplication in the vertical direction of the image is not limited to duplication in the completely vertical direction only, but also includes duplication in the substantially vertical direction.

### [1-1-3. Order of Pupil Expansion]

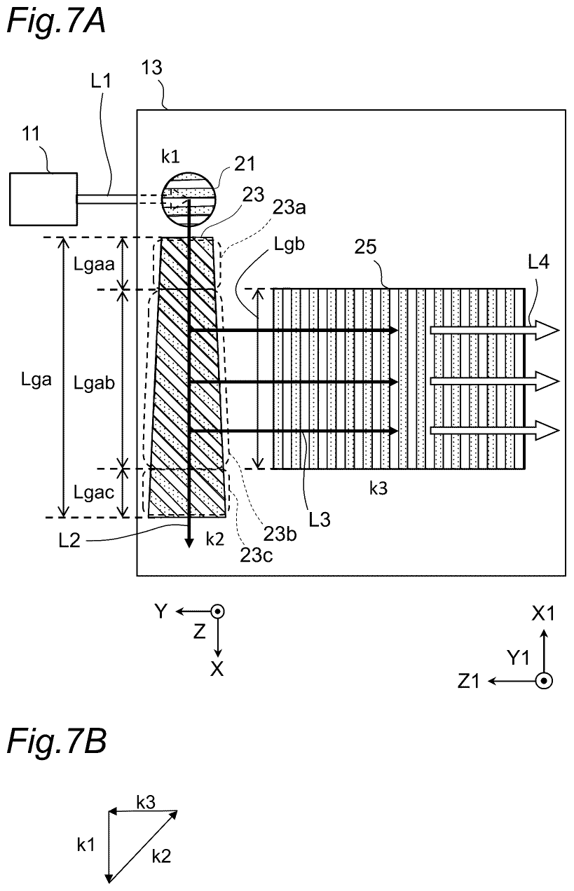

In the light guide 13 of the above arrangement, the HUD system 1 has different magnitudes of the wavenumber vectors of the first expansion region 23 and the second expansion region 25, depending on the order of pupil expansion of the image luminous flux L1. The order of pupil expansion in the embodiment will be described with reference to FIG. 7A-7B. FIG. 7A is an explanatory view showing a central optical path of the luminous flux emitted from the display part. FIG. 7B is an explanatory view showing a wavenumber vector that the diffraction grating of each region in FIG. 7A gives to the luminous flux.

The luminous flux L1 of the image light incident on the light guide 13 changes its direction of propagation toward the first expansion region 23 that expands the pupil in the horizontal direction (X-axis direction) as the first direction by the diffractive structure formed in the coupling region 21. Hence, after the luminous flux L1 enters the coupling region 21 obliquely, it propagates as the luminous flux L2 toward the first expansion region 23 under the action of a wavenumber vector k1 shown in FIG. 7A-7B.

The luminous flux L2 propagating to the first expansion region 23 extending in the first direction is split by the diffractive structure formed in the first expansion region 23 while repeating total reflection into the luminous flux L2 propagating in the first direction and the luminous flux L3 that is replicated and changes the direction of propagation toward the second expansion region 25. At this time, the duplicated luminous flux L3 propagates toward the second expansion region 25 under the action of a wavenumber vector k2 shown in FIG. 7A-7B.

The luminous flux L3, whose direction of propagation has been changed toward the second expansion region 25 extending along the negative direction of the Z1 axis as the second direction, is split by the diffractive structure formed in the second expansion region 25 into the luminous flux L3 propagating in the second direction and the luminous flux L4 that is duplicated and emitted from the second expansion region 25 via the emission surface 27 to the outside of the light guide 13. At this time, the duplicated luminous flux L4 propagates toward the emission surface 27 (see FIG. 6) under the action of a wavenumber vector k3 shown in FIG. 7A-7B.

### [1-1-4. First Expansion Region and Second Expansion Region]

The first expansion region 23 includes a first end region 23a, a central region 23b, and a second end region 23c. The first end region 23a and the second end region 23c are regions that do not overlap with the second expansion region 25 when viewed from the second direction. Hence, the second expansion region 25 exists in the second direction of the central region 23b, while regions without the second expansion region 25 exist in the second direction of the first end region 23a and the second end region 23c.

The size of the second expansion region 25 is determined corresponding to the size of the visual recognition area Ac. In the case that the size of the emission region from which the display part 11 emits the luminous flux L1 is greater than the size of the coupling region 21, the luminous flux L1 incident on the coupling region 21 includes luminous fluxes incident with a tilt angle other than 0 degrees of incidence angle (vertical incidence). If the luminous flux L1 with an incidence angle other than 0 degrees is not guided to the second expansion region 25, a part of the virtual image Iv will be missing in the visual recognition area Ac. Thus, by setting a length Lga of the first expansion region 23 in the first direction to be longer than a length Lgb of the second expansion region 25 in the first direction, the partial missing of the virtual image Iv can be prevented.

The central region 23b of the first expansion region 23 includes the center of the first expansion region 23 in the first direction and lies between the first end region 23a and the second end region 23c. The first end region 23a is the end region closer to the coupling region 21, while the second end region 23c is the end region farther from the coupling region 21.

The length of the first expansion region 23 in the first direction is Lga, the length of the first end region 23a in the first direction is Lgaa, the length of the central region 23b in the first direction is Lgab, and the length of the second end region 23c in the first direction is Lgac. The relationship between these lengths satisfies Formulae (1) to (3) below.

$$Lgaa < Lga / 4 \qquad Formula ( 1 )$$

$$Lga / 4 ≦ Lgab ≦ ( 3 \times Lga ) / 4 \qquad Formula ( 2 )$$

$$Lgac < Lga / 4 \qquad Formula ( 3 )$$

Consequently, the first end region 23a is a region of a length less than ¼ from the end of the first expansion region 23 toward the coupling region 21 in the first direction, and the second end region 23c is a region of a length less than ¼ from the end of the first expansion region 23 opposite the coupling region 21 in the first direction.

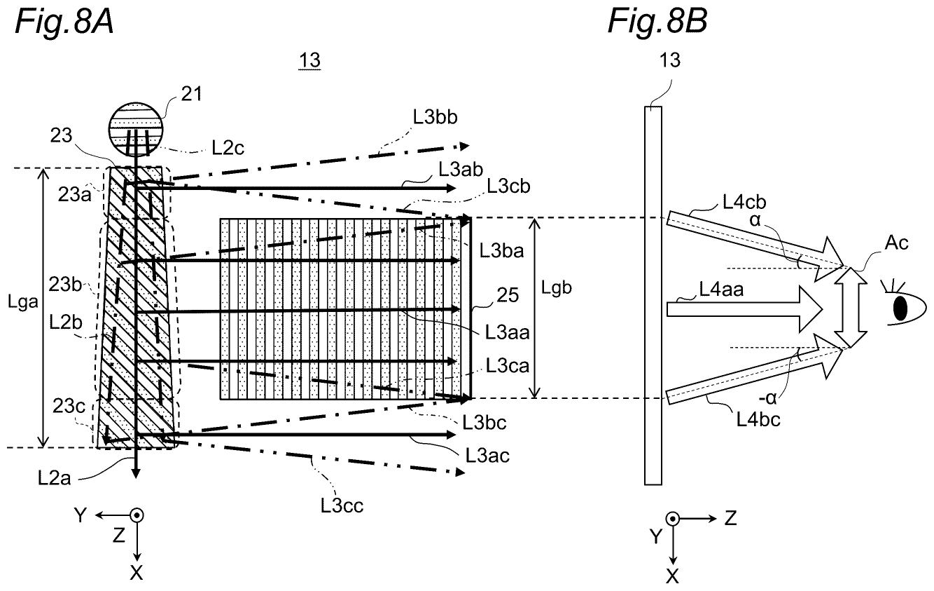

With such a first expansion region 23, expansion of the luminous flux can be achieved as shown in FIG. 8A. The expansion of the luminous flux means increasing the number of luminous fluxes by splitting and duplicating the luminous flux, to thereby expand the visual recognition area Ac. The first expansion region 23 expands the visual recognition area Ac in the horizontal direction, while the second expansion region 25 expands the visual recognition area Ac in the vertical direction. The luminous flux L2 traveling in the first direction from the coupling region 21 through the first expansion region 23 includes a luminous flux L2a, a luminous flux L2b, and a luminous flux L2c. The luminous flux L3 traveling in the second direction from the first expansion region 23 includes a luminous flux L3aa, a luminous flux L3ab, a luminous flux L3ac, a luminous flux L3ba, a luminous flux L3bb, a luminous flux L3bc, a luminous flux L3ca, a luminous flux L3cb, and a luminous flux L3cc.

The luminous flux L2a, whose direction of travel is changed from that of the component of the luminous flux L1 incident perpendicularly on the coupling region 21, travels in the first direction through the first expansion region 23, with the luminous flux L3ab split and diffracted in the first end region 23a, the luminous flux L3aa split and diffracted in the central region 23b, and the luminous flux L3ac split and diffracted in the second end region 23c each traveling in the second direction. The luminous flux L3aa can travel into the second expansion region 25, but the luminous fluxes L3ab and L3ac cannot travel into the second expansion region 25, resulting in a loss in light quantity.

The luminous flux L2b, whose direction of travel is changed from that of the component of the luminous flux L1 incident at a positive angle tilt on the coupling region 21, travels in the first direction through the first expansion region 23, with the luminous flux L3bb split and diffracted in the first end region 23a, the luminous flux L3ba split and diffracted in the central region 23b, and the luminous flux L3bc split and diffracted in the second end region 23c each traveling in the second direction. The luminous flux L3bc travels into the second expansion region 25 to prevent the virtual image Iv from being partially missing, but a part of the luminous flux L3ba and the luminous flux L3bb cannot travel into the second expansion region 25, so that a loss in light quantity occurs.

The luminous flux L2c, whose direction of travel is changed from that of the component of the luminous flux L1 incident at a negative angle tilt on the coupling region 21, travels in the first direction through the first expansion region 23, with the luminous flux L3cb split and diffracted in the first end region 23a, the luminous flux L3ca split and diffracted in the central region 23b, and the luminous flux L3cc split and diffracted in the second end region 23c each traveling in the second direction. The luminous flux L3cb travels into the second expansion region 25 to prevent the virtual image Iv from being partially missing, but a part of the luminous flux L3ca and the luminous flux L3cc cannot travel into the second expansion region 25, so that a loss in light quantity occurs.

In this way, partial missing of the virtual image Iv can be prevented from occurring, but a loss in light quantity occurs accordingly. Compared to the luminous flux L3aa, the luminous flux L3bc and the luminous flux L3cb diffract less frequently in the second expansion region 25 and propagate with less loss in light quantity through repeated total reflection in the light guide 13. In consequence, the luminous fluxes L3bc and L3cb have a larger light quantity than the luminous flux L3aa that propagates while being split by diffraction within the second expansion region 25, causing luminance unevenness of the image light emitted from the second expansion region 25.

Thus, in this embodiment, the loss in the light quantity and the luminance unevenness are reduced while preventing the image from being partially missing by modulating the transition of the first direction of the quantity of light diffracted from the first expansion region 23. Specifically, the diffraction efficiency of the first end region 23a and the second end region 23c is modulated so as to reduce the quantity of light of the luminous fluxes L3ab, L3bb, L3ac, and L3cc.

The luminous fluxes emitted from the second expansion region 25 within the range of the length Lgb in the first direction of the second expansion region 25 shown in FIG. 8A are incident on the visual recognition area Ac in a range of the horizontal viewing angle θ of −α≤θ≤α, as shown in FIG. 8B. In the second expansion region 25, the luminous flux L3aa is diffracted to generate the luminous flux L4aa, the luminous flux L3cb is diffracted to generate the luminous flux L4cb, and the luminous flux L3bc is diffracted to generate the luminous flux L4bc. These luminous fluxes L4aa, L4cb, and L4bc reach the visual recognition area Ac. The luminous fluxes diffracted from the luminous fluxes Lab, L3bb, L3ac, L3cc, L3ba, and L3ca not emitted within the range of the length Lgb of the second expansion region 25 in the first direction do not reach the visual recognition area Ac. In FIG. 8B, the windshield 5 is not shown for ease of understanding.

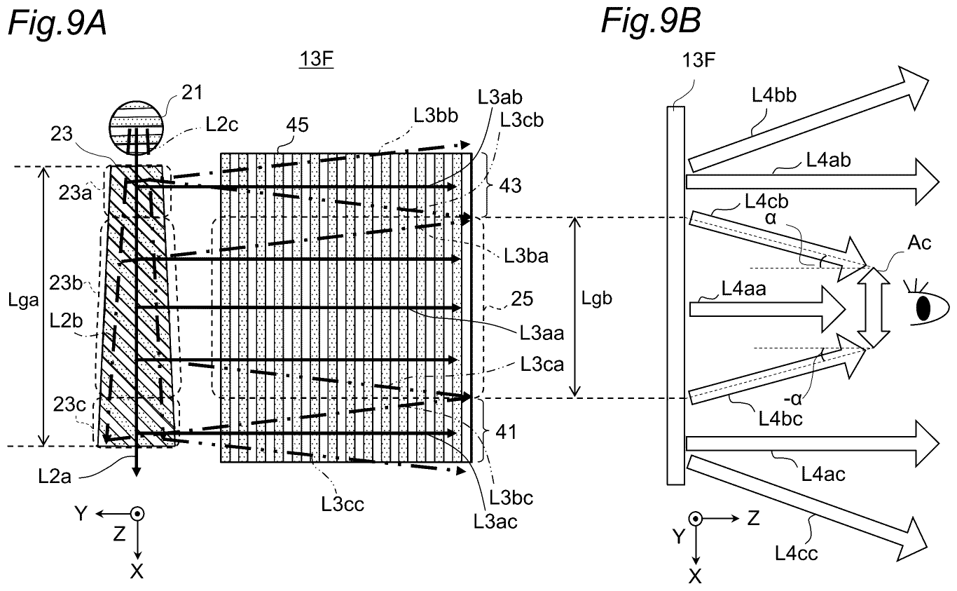

As shown in FIG. 9A, the second expansion region 25 may be formed with regions 41 and 43 expanding in the positive direction (X-axis positive direction) and negative direction (X-axis negative direction), respectively, of the first direction. The HUD system 1 may include a light guide 13F in which an expansion region 45 having the second expansion region 25 and the regions 41 and 43 is arranged in the second direction of the first expansion region 23. As in FIGS. 8A and 8B, the luminous fluxes L4aa, L4cb, and L4bc reach the visual recognition area Ac.

On the other hand, the light diffracted from the luminous fluxes L3ab, L3bb, L3ac, and L3cc not emitted within the range of the length Lgb in the first direction of the second expansion region 25 of the light guide 13F does not reach the visual recognition area Ac from the light guide 13F. In the second expansion region 25, the luminous flux L3ab is diffracted to generate the luminous flux L4ab, the luminous flux L3bb is diffracted to generate the luminous flux L4bb, the luminous flux L3ac is diffracted to generate the luminous flux L4ac, and the luminous flux L3cc is diffracted to generate the luminous flux L4cc. As shown in FIG. 9B, these luminous fluxes L4ab, L4bb, L4ac, and L4cc do not reach the visual recognition area Ac. In FIG. 9B, the windshield 5 is not shown for ease of understanding. In the expansion region 45, the expansion region within the range of length Lgb where the light is incident within the viewing angle θ in the range of −α≤θ≤α is the second expansion region 25.

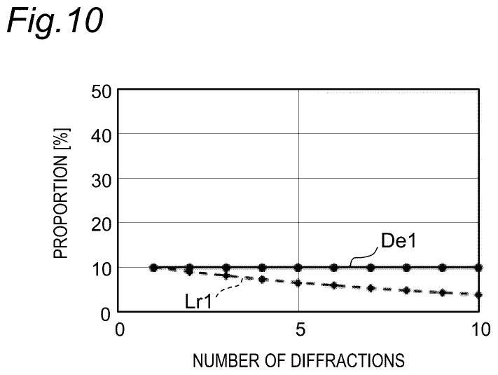

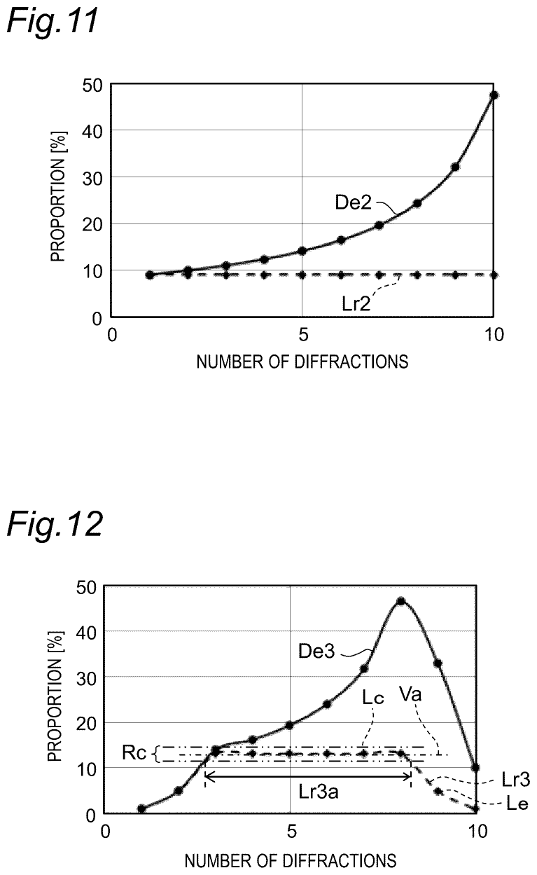

Referring then to FIGS. 10 to 12, the modulation of the proportion of the quantity of light diffracted in the first direction in the first expansion region 23 will be described. FIG. 10 is a graph showing the transition of the proportion of the quantity of light diffracted when the modulation of the diffraction efficiency is not performed in a comparative example. FIG. 11 is a graph showing the modulation of the diffraction efficiency performed so that the transition of the proportion of the quantity of light diffracted becomes constant in the comparative example. FIG. 12 is a graph showing the modulation of the diffraction efficiency and the transition of the proportion of the quantity of light diffracted in the embodiment.

As in the comparative example shown in FIG. 10, when a diffraction efficiency De1 is constant with no modulation in the first direction in the first expansion region 23, a proportion Lr1 of the quantity of light diffracted is highest in the first end region 23a with a small number of diffractions and decreases according as the number of diffractions increases in the first direction. It therefore causes luminance unevenness of the virtual image Iv.

Next, as in the comparative example shown in FIG. 11, by modulating and gradually increasing a diffraction efficiency De2 in the first direction in the first expansion region 23, a proportion Lr2 of the quantity of light diffracted can be made constant irrespective of the number of diffractions. In this embodiment, however, the length Lga of the first expansion region 23 in the first direction is longer than the length Lgb of the second expansion region 25 in the first direction, so that light quantity loss and luminance unevenness occur for the reasons described above.

Thus, in this embodiment, the modulation of the diffraction efficiency is carried out as shown in FIG. 12. In the first expansion region 23, a proportion Lr3 of the quantity of light diffracted gradually increases along the first direction and has a flat portion Lr3a where the proportion Lr3 of the quantity of light falls within a certain range Rc in a specific range of the number of diffractions. The certain range Rc in the flat portion Lr3a is a range within ±10% of a design value Va of the proportion of the quantity of light diffracted in the central region 23b. The design value Va is a specific value designed according to the number of diffractions in the central region 23b. In this embodiment, the design value Va is approx. 13%.

In this way, in the first expansion region 23, the proportion Lr3 of the quantity of light diffracted in the first end region 23a with a small number of diffractions and the second end region 23c with a large number of diffractions is set to be lower than the proportion Lr3 of the quantity of light diffracted in the central region 23b. To achieve this transition of the proportion Lr3 of the quantity of light, a diffraction efficiency De3 in the first expansion region 23 is increased as the number of diffractions increases, and the diffraction efficiency De3 is decreased when the number of diffractions exceeds a specific number of diffractions. The diffraction efficiency De3 is increased along the first direction from the first end region 23a to the central region 23b and is decreased along the first direction in the second end region 23c. A diffracted light quantity Le in the first end region 23a and the second end region 23c of the first expansion region 23 is less than half the diffracted light quantity Lc in the central region 23b of the first expansion region 23. Thus, a conditional expression of Formula (4) is established.

$$L e < Lc / 2 \qquad Formula ( 4 )$$

Thus, by reducing the light quantity loss of the luminous fluxes L3ab and L3ac, the quantity of light of the luminous flux L3aa can be increased by the reduced quantity of light. By reducing the light quantity loss of the luminous fluxes L3bb and L3cc, etc., at high viewing angles and reducing the quantity of light of the luminous fluxes L3bc and L3cb for propagation to the second expansion region 25C, it is possible to prevent the occurrence of partial missing of the image and improve the luminance unevenness of the virtual image Iv.

### [1-1-5. Diffraction Grating]

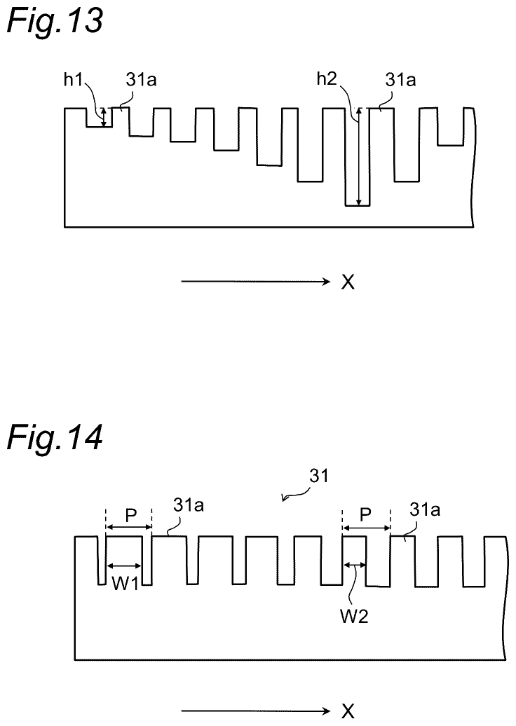

Referring then to FIG. 13, the diffractive structure of the first expansion region 23 will be described. FIG. 13 is a longitudinal cross-sectional view of a diffraction grating 31 disposed in the first expansion region 23.

The diffraction grating 31 diffracting the incident luminous flux is disposed in the first expansion region 23. The diffraction grating 31 is, for example, a transparent resin layer and is formed by nanoimprinting. Alternatively, instead of nanoimprinting, for example, the diffraction grating 31 may be formed by dry etching a layer of SiO₂ on a substrate 35, which is a glass substrate. The diffraction grating 31 is disposed in the second expansion region 25 in the same manner.

The diffraction grating 31 is formed periodically at a pitch P. The diffraction grating 31 has structural features determined by a height h from the surface, a width W, and a duty ratio Dr defined by the width W/pitch P. The diffraction grating 37 may have a slant angle.

The higher the height of the diffraction grating 31, the higher the diffraction efficiency. A height h1 of a grating 31a in the first end region 23a and the second end region 23c of the first expansion region 23 is lower than a height h2 of the grating 31a in the central region 23b. In this way, by modulating the height of the grating 31a, the quantity of light diffracted in the first end region 23a and the second end region 23c can be less than the quantity of light diffracted in the central region 23b.

As shown in FIG. 14, the absolute value of the difference between a duty ratio Dr1 of the diffraction grating in the first end region 23a and the second end region 23c of the first expansion region 23 and 0.5 is greater than the absolute value of the difference between a duty ratio Dr2 of the diffraction grating in the central region 23b and 0.5. In consequence, a conditional expression of Formula (5) below is satisfied.

$$\vert Dr 1 - 0.5 \vert > \vert Dr 2 - 0.5 \vert \qquad Formula ( 5 )$$

That is, the duty ratio Dr2 of the diffraction grating in the central region 23b is closer to 0.5 than the duty ratio Dr1 of the diffraction grating in the first end region 23a and the second end region 23c. By modulating the duty ratio in this manner, the quantity of light diffracted in the first end region 23a and the second end region 23c can be less than the quantity of light diffracted in the central region 23b.

By combining modulation of the diffraction grating height and modulation of the duty ratio, the quantity of light diffracted in the first end region 23a and the second end region 23c may be set less than the quantity of light diffracted in the central region 23b.

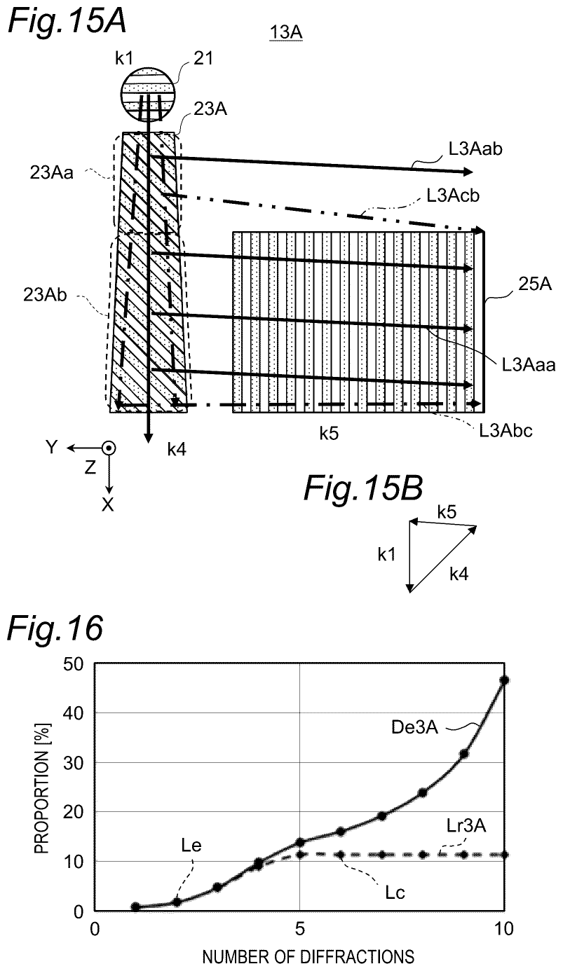

A first modification of the embodiment will then be described with reference to FIG. 15A-15B. FIG. 15A is an explanatory view showing optical paths of luminous fluxes traveling through the first expansion region 23A and the second expansion region 25A of the light guide 13A in the first modification of the embodiment. FIG. 15B is an explanatory view showing wavenumber vectors given to the luminous flux by the diffraction gratings of the coupling region 21 and expansion regions 23A and 25A in FIG. 15A. The second expansion region 25A has a first end region 23Aa and a central region 23Ab.

The diffraction gratings of the first and second expansion regions 23A and 25A are each designed so that a wavenumber vector k5 by the diffraction grating of the second expansion region 25A is slightly inclined as shown in FIG. 15B. This allows the sum of a wavenumber vector k1 of the coupling region 21, a wavenumber vector k4 of the first expansion region 23A, and the wavenumber vector k5 of the second expansion region 25A to be zero. By making the wavenumber vector k5 inclined, the center of the second expansion region 25A in the first direction can be placed on the first direction side of the first expansion region 23A instead of being aligned with the center of the first expansion region 23A in the first direction, as shown in FIG. 15A. The sizes of the first end region 23Aa and the central region 23Ab in the first expansion region 23A are larger than the sizes of the first end region 23a and the central region 23b of the first embodiment and are each expanded to the first direction side.

By positioning the second expansion region 25A to overlap with the first expansion region 23A at the side of the first expansion region 23A opposite to the coupling region 21 as viewed from the second direction, the space at the edge on the first direction side of the second expansion region 25A can be curtailed.

Referring to FIG. 16, the transition of the proportion of the quantity of light diffracted in the first expansion region 23A of the first modification of the embodiment will be described. FIG. 16 is a graph showing the modulation of the diffraction efficiency of the first expansion region 23A and the transition of the proportion of the quantity of light diffracted in the first modification of the embodiment.

In the first expansion region 23A, a proportion Lr3A of the quantity of light diffracted in the first end region 23Aa with a small number of diffractions is set lower than the proportion Lr3A of the quantity of light in the central region 23Ab. To achieve this transition of the proportion Lr3A of the quantity of light, a diffraction efficiency De3A is increased as the number of diffractions increases. The diffraction efficiency De3A is increased along the first direction from the first end region 23Aa to the central region 23Ab. The diffracted light quantity Le in the first end region 23Aa of the first expansion region 23A is less than half the diffracted light quantity Lc in the central region 23Ab of the first expansion region 23.

This can reduce the light quantity loss of the luminous flux L3Aab and increase the quantity of light of the luminous flux L3Aaa by the reduced quantity. By reducing the light quantity loss at a high viewing angle and reducing the quantity of light of the luminous flux L3Acb for propagation to the second expansion region 25A, the luminance unevenness of the virtual image Iv can be improved.

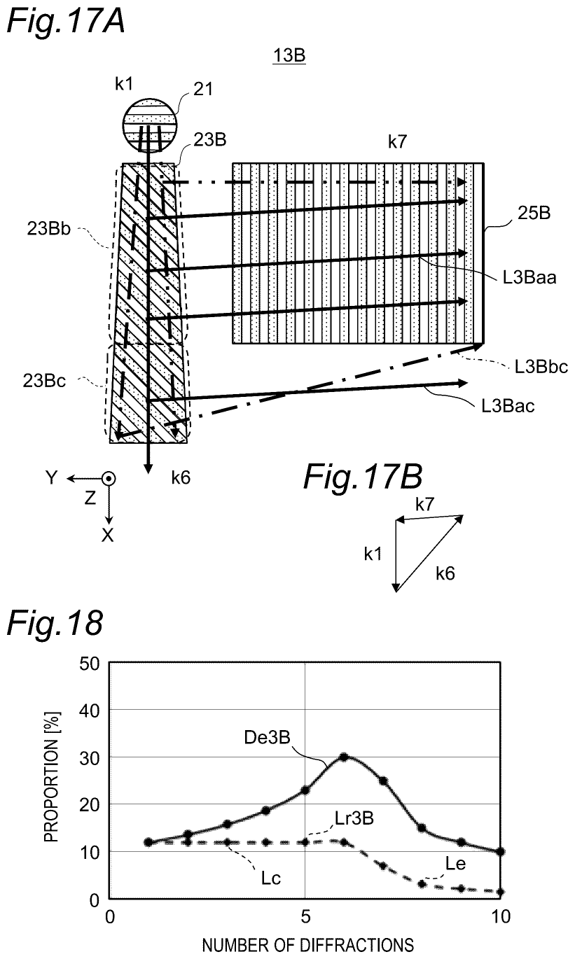

A second modification of the embodiment will then be described with reference to FIG. 17A-17B. FIG. 17A is an explanatory view showing optical paths of luminous fluxes traveling through a first expansion region 23B and a second expansion region 25B of a light guide 13B in the second modification of the embodiment. FIG. 17B is an explanatory view showing wavenumber vectors given to the luminous flux by the diffraction gratings of the coupling region 21 and the expansion regions 23B and 25B in FIG. 17A. The second expansion region 25B has a central region 23Bb and a second end region 23Bc.

The diffraction gratings of the first expansion region 23B and the second expansion region 25B are each designed so that a wavenumber vector k7 by the diffraction grating of the second expansion region 25B is inclined as shown in FIG. 17B. This allows the sum of the wavenumber vector k1 of the coupling region 21, a wavenumber vector k6 of the first expansion region 23B, and the wavenumber vector k7 of the second expansion region 25B to be zero. By making the wavenumber vector k7 inclined, the center of the second expansion region 25B in the first direction can be placed toward the coupling region 21, instead of being aligned with the center of the first expansion region 23B in the first direction, as shown in FIG. 17A. The sizes of the central region 23Bb and the second end region 23Bc in the first expansion region 23B are larger than the sizes of the central region 23b and the second end region 23c of the first embodiment and are each expanded in the opposite direction to the first direction.

By positioning the second expansion region 25B to overlap with the first expansion region 23B at the coupling region 21 side of the first expansion region 23B as viewed from the second direction, the space at the edge of the second expansion region 25B opposite the first direction can be curtailed.

Referring to FIG. 18, the transition of the proportion of the quantity of light diffracted in the first expansion region 23A of the second modification of the embodiment will be described. FIG. 18 is a graph showing the modulation of the diffraction efficiency of the first expansion region 23B and the transition of the proportion of the quantity of light diffracted in the second modification of the embodiment.

In the first expansion region 23B, a proportion Lr3B of the quantity of light diffracted in the second end region 23Bc with a large number of diffractions is set lower than the proportion Lr3B of the quantity of light diffracted in the central region 23Bb. To achieve this transition of the proportion Lr3B of the quantity of light, a diffraction efficiency De3B is increased as the number of diffractions increases, and the diffraction efficiency De3B is decreased when the number of diffractions exceeds a specific number of diffractions. The diffraction efficiency De3B is increased along the first direction in the central region 23Bb and is decreased along the first direction in the second end region 23Bc. The diffracted light quantity Le in the second end region 23Bc of the first expansion region 23B is less than half the diffracted light quantity Lc in the central region 23Bb of the first expansion region 23B.

This can reduce the light quantity loss of the luminous flux L3Bac and increase the quantity of light of the luminous flux L3Baa by the reduced quantity. By reducing the light quantity loss at a high viewing angle and reducing the quantity of light of the luminous flux L3Abc for propagation to the second expansion region 25A, the luminance unevenness of the virtual image Iv can be improved.

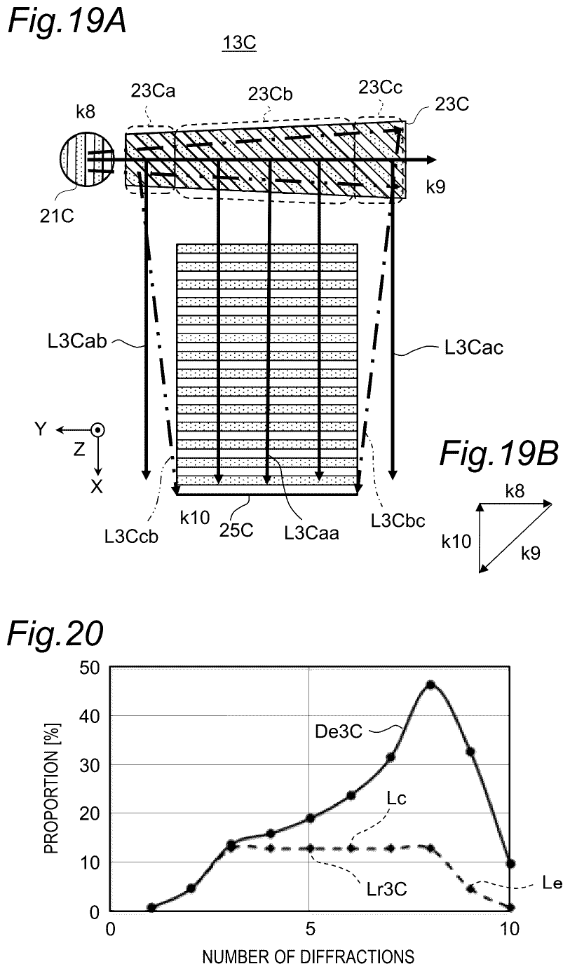

A third modification of the embodiment will then be described with reference to FIG. 19A-19B. FIG. 19A is an explanatory view showing optical paths of the luminous fluxes traveling through a first expansion region 23C and a second expansion region 25C of a light guide 13C in the third modification of the embodiment. FIG. 19B is an explanatory view showing wavenumber vectors given to the luminous flux by the diffraction gratings of a coupling region 21C and the expansion regions 23C and 25C in FIG. 19A. In the third modification of the embodiment, a first direction of the first expansion region 23C is the negative direction of the Y axis, and a second direction of the second expansion region 25C is the direction of the X axis.

The luminous flux incident on the coupling region 21C propagates in the direction where the first expansion region 23C is disposed under the action of the wavenumber vector k1 by the diffraction grating of the coupling region 21C. The luminous flux propagating to the first expansion region 23C is split into a luminous flux propagating in the first direction and a luminous flux that is duplicated and changes its direction of propagation toward the second expansion region 25C, by the diffractive structure formed in the first expansion region 23C while repeating total reflection. At this time, the duplicated luminous flux propagates in the direction where the second expansion region 25C is disposed under the action of a wavenumber vector k9. The luminous flux whose direction of propagation has been changed toward the second expansion region 25C is split into a luminous flux propagating in the second direction and a luminous flux that is duplicated and emitted from the second expansion region 25C to the outside of the light guide 13C by the diffractive structure formed in the second expansion region 25C. At this time, the duplicated luminous flux is subjected to the action of a wavenumber vector k10 by the diffraction grating of the second expansion region 25C to be emitted to the outside of the light guide 13C.

In the first expansion region 23C, a proportion Lr3C of the quantity of light diffracted in a first end region 23Ca with a small number of diffractions and a second end region 23Cc with a large number of diffractions is set lower than the proportion Lr3C of the quantity of light diffracted in a central region 23Cb. To achieve this transition of the proportion Lr3C of the quantity of light, a diffraction efficiency De3C is increased as the number of diffractions increases, and the diffraction efficiency De3C is decreased when the number of diffractions exceeds a specific number of diffractions. As shown in FIG. 20, the diffraction efficiency De3C is increased along the first direction from the first end region 23Ca to the central region 23Cb and is decreased along the first direction in the second end region 23Cc. The diffracted light quantity Le in the first end region 23Ca and the second end region 23Cc of the first expansion region 23C is less than half the diffracted light quantity Lc in the central region 23Cb of the first expansion region 23C.

Thus, by reducing the light quantity loss of the luminous fluxes L3Cab and L3Cac, the quantity of light of the luminous flux L3Caa can be increased by the reduced quantity of light. By reducing the light quantity loss at a high viewing angle and reducing the quantity of light of the luminous fluxes L3Cbc and L3Ccb for propagation to the second expansion region 25C, it is possible to prevent the occurrence of partial missing of the image and improve the luminance unevenness of the virtual image Iv. By setting the direction of the first expansion by the first expansion region 23C to be along the Y-axis direction, the size of the light guide 13C in the Y-axis direction can be shortened.

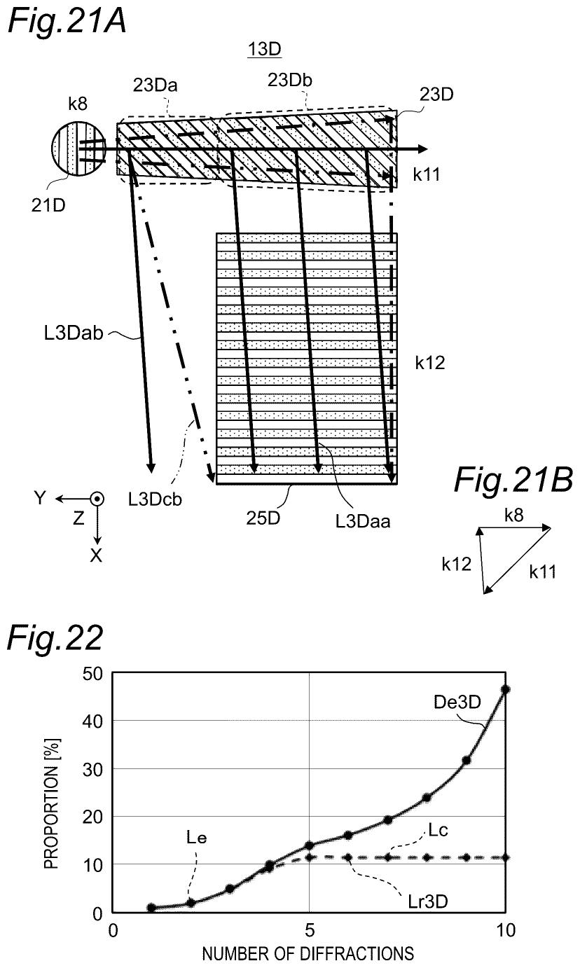

A fourth modification of the embodiment will then be described with reference to FIG. 21A-21B. FIG. 21A is an explanatory view showing optical paths of luminous fluxes traveling through a first expansion region 23D and a second expansion region 25D of a light guide 13D in the fourth modification of the embodiment. FIG. 21B is an explanatory view showing wavenumber vectors given to the luminous flux by the diffraction gratings of a coupling region 21D and the expansion regions 23D and 25D in FIG. 21A. The fourth modification of the embodiment is an example in which the first modification and the third modification are combined. The diffraction gratings of the first expansion region 23D and the second expansion region 25D are each designed so that a wavenumber vector k12 by the diffraction grating of the second expansion region 25D is inclined. This allows the sum of a wavenumber vector k8 of the coupling region 21D, a wavenumber vector k11 of the first expansion region 23D, and the wavenumber vector k12 of the second expansion region 25D to be zero. By making the wavenumber vector k12 inclined, the center of the second expansion region 25D in the first direction can be arranged on the first direction side with respect to the first expansion region 23D, instead of being aligned with the center of the first expansion region 23D in the first direction, as shown in FIG. 21A. The sizes of a first end region 23Da and a central region 23Db in the first expansion region 23D are larger than the sizes of the first end region 23Ca and the central region 23Cb in the third modification and are each expanded toward the first direction side.

By positioning the second expansion region 25D to overlap with the first expansion region 23D at the side of the first expansion region 23D opposite to the coupling region 21 as viewed from the second direction, the space at the edge on the first direction side of the second expansion region 25D can be curtailed.

The transition of the proportion of the quantity of light diffracted in the first expansion region 23D of the fourth modification of the embodiment will be described with reference to FIG. 22. FIG. 22 is a graph showing the modulation of the diffraction efficiency of the first expansion region 23D and the transition of the proportion of the quantity of light diffracted in the fourth modification of the embodiment.

In the first expansion region 23D, a proportion Lr3D of the quantity of light diffracted in a first end region 23Da with a small number of diffractions is set lower than the proportion Lr3D of the quantity of light diffracted in a central region 23Db. To achieve this transition of the proportion Lr3D of the quantity of light, a diffraction efficiency De3D is increased as the number of diffractions increases. The diffraction efficiency De3D is increased along the first direction from the first end region 23Da to the central region 23Db. The diffracted light quantity Le in the first end region 23Da of the first expansion region 23D is less than half the diffracted light quantity Lc in the central region 23Db of the first expansion region 23D.

This can reduce the light quantity loss of the luminous flux L3Dab and increase the quantity of light of the luminous flux L3Daa by the reduced quantity. By reducing the light quantity loss at a wide viewing angle and reducing the quantity of light of the luminous flux L3Dcb to propagate to the second expansion region 25D, it is possible to prevent the occurrence of partial missing of the image and improve the luminance unevenness of the virtual image Iv.

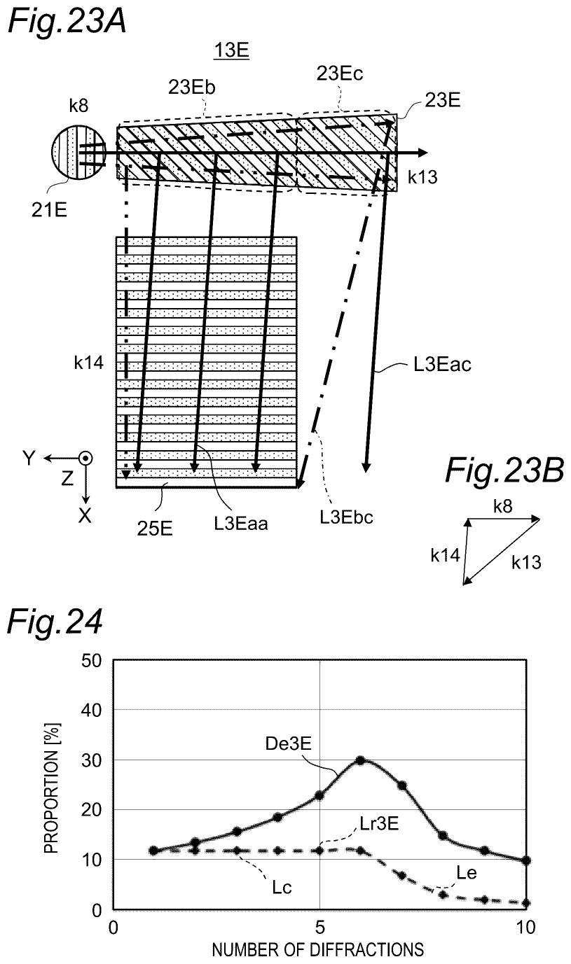

A fifth modification of the embodiment will then be described with reference to FIG. 23A-23B. FIG. 23A is an explanatory view showing optical paths of luminous fluxes traveling through a first expansion region 23E and a second expansion region 25E of a light guide 13E in the fifth modification of the embodiment. FIG. 23B is an explanatory view showing wavenumber vectors given to the luminous flux by the diffraction gratings of a coupling region 21E and the expansion regions 23E and 25E in FIG. 23A. The fifth modification of the embodiment is an example in which the second modification and the third modification are combined.

The diffraction gratings of the first expansion region 23E and the second expansion region 25E are each designed so that a wavenumber vector k14 by the diffraction grating of the second expansion region 25E is inclined. This allows the sum of a wavenumber vector k8 of the coupling region 21E, a wavenumber vector k13 of the first expansion region 23E, and the wavenumber vector k14 of the second expansion region 25E to be zero. By making the wavenumber vector k14 inclined, the center of the second expansion region 25E in the first direction can be arranged on the coupling region 21E side instead of being aligned with the center of the first expansion region 23E in the first direction. The sizes of the central region 23Eb and the second end region 23Ec in the first expansion region 23E are larger than the sizes of the central region 23b and the second end region 23c of the first embodiment and are each expanded in the opposite direction to the first direction.

By positioning the second expansion region 25E to overlap with the first expansion region 23E at the coupling region 21 side of the first expansion region 23E as viewed from the second direction, the space at the edge of the second expansion region 25E opposite the first direction can be curtailed.

The transition of the proportion of the quantity of light diffracted in the first expansion region 23E of the fifth modification of the embodiment will be described with reference to FIG. 24. FIG. 24 is a graph showing the modulation of the diffraction efficiency of the first expansion region 23E and the transition of the proportion of the quantity of light diffracted in the fifth modification of the embodiment.

In the first expansion region 23E, a proportion Lr3E of the quantity of light diffracted in a second end region 23Ec with a large number of diffractions is set lower than the proportion Lr3E of the quantity of light diffracted in a central region 23Eb. To achieve this transition of the proportion Lr3E of the quantity of light, a diffraction efficiency De3E is increased as the number of diffractions increases, and the diffraction efficiency De3E is decreased when the number of diffractions exceeds a specific number of diffractions. The diffraction efficiency De3E is increased along the first direction in the central region 23Eb and is decreased along the first direction in the second end region 23Ec. The diffracted light quantity Le in the second end region 23Ec of the first expansion region 23E is less than half the diffracted light quantity Lc in the central region 23Eb of the first expansion region 23E.

This can reduce the light quantity loss of the luminous flux L3Eac and increase the quantity of light of a luminous flux L3Eaa by the reduced quantity. By reducing the light quantity loss at a wide viewing angle and reducing the quantity of light of a luminous flux L3Ebc for propagation to the second expansion region 25E, it is possible to prevent the occurrence of partial missing of the image and improve the luminance unevenness of the virtual image Iv.

### [1-2. Effects, Etc.]

The light guide 13 as an optical system of the present disclosure is an optical system that allows the observer D to visually recognize a virtual image Iv. The light guide 13 includes the first expansion region 23 that expands the luminous flux L2 traveling in the first direction by splitting and duplicating it into the luminous fluxes L3 traveling in the second direction intersecting the first direction to increase the number of luminous fluxes, and the second expansion region 25 that expands the luminous fluxes traveling in the second direction by splitting and duplicating them to increase the number of luminous fluxes, the second expansion region 25 corresponding to the visual recognition area Ac of the virtual image Iv. The first expansion region 23 includes the central region 23b containing the center of the first expansion region 23, and at least one of the first end region 23a and the second end region 23c which lie on at least one of end sides of the first expansion region 23 and whose diffracted light quantity is less than half the diffracted light quantity in the central region 23b.

Since the diffracted light quantity Le in the first end region 23a or the second end region 23c is less than half the diffracted light quantity Lc in the central region 23b of the first expansion region 23, the quantity of light luminous flux diffracted in the first end region 23a or the second end region 23c can be reduced, leading to reduced light quantity loss. Furthermore, the luminous flux diffracted in the first end region 23a or the second end region 23c and reaching the second expansion region 25 is a luminous flux with high luminance due to a small number of diffractions, but since the quantity of this luminous flux can be reduced, luminance unevenness can be reduced.

The second expansion region 25 lies in the second direction of the central region 23b, and a region without the second expansion region 25 lies in the second direction of the first end region 23a and the second end region 23c. The region without the second expansion region 25 can reduce the transmission of the luminous flux toward the observer D outside the visual recognition area Ac. Furthermore, if there is an expansion region other than the second expansion region 25 in a region exceeding the length Lgb in the first direction, the luminous flux from the first end region 23a and the second end region 23c is diffracted in this expansion region and does not reach the visual recognition area Ac, but the presence of a region without the second expansion region 25 in the second direction of the first end region 23a and the second end region 23c can reduce this diffraction and increase the quantity of light that reaches the visual recognition area Ac.

The length Lga in the first direction of the first expansion region 23 is longer than the length Lgb in the first direction of the second expansion region 25. This makes it possible to prevent partial missing of the image by the luminous flux that is diffracted in the first end region 23a or the second end region 23c to reach the second expansion region 25.

In addition, by projecting the light emitted from the light guide 13 as an optical system onto the windshield 5 of the vehicle 3, a complete virtual image Iv with proper luminance can be displayed to the observer D driving the vehicle 3.

### OTHER EMBODIMENTS

As described above, the above embodiment has been set forth as an example of the technology disclosed in this application. The technology in this disclosure, however, is not limited thereto, and can be applied to embodiments in which modifications, permutations, additions, omissions, etc. are made as appropriate. Other embodiments will thus be exemplified below.

In the above embodiment, the split and duplicated luminous flux L2 is reflected by the windshield 5 to allow the observer D to visually recognize the virtual image Iv, but this is not limitative. A combiner may be used instead of the windshield 5, and the split and duplicated luminous flux L2 may be reflected by the combiner to allow the observer D to visually recognize the virtual image Iv.

In the above embodiment, the case has been described where the HUD system 1 is applied to a vehicle 3 such as an automobile. The object to which the HUD system 1 is applied, however, is not limited to the vehicle 3. The object to which the HUD system 1 is applied may be, for example, a train, a motorcycle, a ship, or an aircraft, or may be an amusement machine that does not involve movement. In the case of an amusement machine, the luminous flux from the display part 11 is reflected by a transparent curved plate as a light-transmitting member that reflects the luminous flux emitted from the display part 11 instead of the windshield 5. The real scene visible to the user through the transparent curved plate may be an image displayed from another image display. In other words, a virtual image by the HUD system 1 may be displayed superimposed on an image displayed from another image display. In this way, any of the windshield 5, the combiner, and the transparent curved plate may be employed as the light-transmitting member in the present disclosure.

In the above embodiment, the light guide 13 is used in the HUD system 1 that displays the virtual image Iv, but this is not limitative. The light guide 13 may be used for an HMD.

Although in the above embodiment, the light guide 13 is used in the HUD system 1 that displays the virtual image Iv, this is not limitative. The light guide 13 may be used in an image display system in which the observer directly observes the luminous flux emitted from the emission surface 27, instead of viewing the virtual image through a light-transmitting member. In this case, the observer is a person who directly views the image formed by the emitted luminous fluxes, and is therefore not limited to a passenger on a moving object.

### OVERVIEW OF EMBODIMENT

(1) An optical system of the present disclosure is an optical system for allowing an observer to visually recognize an image, including: a first expansion region that expands a luminous flux traveling in a first direction by splitting and duplicating it into luminous fluxes traveling in a second direction intersecting the first direction to increase the number of luminous fluxes; and a second expansion region that expands the luminous fluxes traveling in the second direction by splitting and duplicating them to increase the number of luminous fluxes, the first expansion region having a central region that contains a center of the first expansion region, and an end region that lies on at least one end side of the first expansion region, the end region having a diffracted light quantity less than half the diffracted light quantity in the central region.

Since the diffracted light quantity in at least one end region is less than half the diffracted light quantity in the central region of the first expansion region, it is possible to reduce the quantity of light diffracted in the end region and reduce the light quantity loss. Although the luminous flux diffracted in the end region and reaching the second expansion region is a luminous flux with high luminance due to a small number of diffractions, the quantity of light of this luminous flux can be reduced, so that the luminance unevenness can be reduced.

(2) In the optical system of (1), the second expansion region lies in the second direction of the central region, wherein a region without the second expansion region lies in the second direction of the end region. The region without the second expansion region can reduce the luminous fluxes transmitted toward an observer in a region outside the visual recognition area and reduce the diffractions of the luminous flux from the end region in a region other than the second expansion region that does not reach the visual recognition area, to thereby increase the quantity of light that reaches the visual recognition area.

(3) In the optical system of (1) of (2), a length in the first direction of the first expansion region is longer than a length in the first direction of the second expansion region. This can prevent the image from being partially missing by luminous fluxes diffracted in the end region and reaching the second expansion region.

(4) In the optical system of any one (1) to (3), in a transition of a proportion of a diffracted light quantity along the first direction in the first expansion region, the proportion of the diffracted light quantity in the central region of the first expansion region overlapping with the second expansion region when viewed from the second direction is within a range of ±10% of a design value. This makes it possible to keep constant the quantity of light diffracted from the central region of the first expansion region to the second direction, consequently reducing the luminance unevenness.

(5) In the optical system of any one of (1) to (4), in the end region of the first expansion region, the diffracted light quantity increases from an end of the end region away from the central region of the first expansion region toward the central region. As a result, in the end region of the first expansion region, the diffracted light quantity increases toward the central region, so that the quantity of light diffracted at the end of the end region can be reduced, leading to reduced light quantity loss.

(6) In the optical system of any one of (1) to (5), the central region of the first expansion region is a region having a length of ¼ or more and ¾ or less from an end in the first direction, while the end region is a region having a length of less than ¼ from an end in the first direction.

(7) The optical system of any one of (1) to (6) includes a coupling region that changes a traveling direction of an incident luminous flux toward the first expansion region, wherein the end region of the first expansion region is a region closer to the coupling region.

(8) The optical system of any one of (1) to (6) includes a coupling region that changes a traveling direction of an incident luminous flux toward the first expansion region, wherein the end region of the first expansion region is a region farther from the coupling region.

(9) In the optical system of any one of (1) to (8), the first expansion region includes a diffraction grating, wherein a height of the diffraction grating in the end regions of the first expansion region is lower than a height of the diffraction grating in the central region. This makes it possible to modulate the diffraction efficiency of the first expansion region to have a desired transition.

(10) In the optical system of any one of (1) to (8), the first expansion region includes a diffraction grating, wherein a difference between a duty ratio value of a diffraction grating in the end region of the first expansion region and 0.5 is greater than a difference between a duty ratio value of a diffraction grating in the central region and 0.5. This makes it possible to modulate the diffraction efficiency of the first expansion region to have a desired transition.

(11) In the optical system of any one of (1) to (8), the first expansion region includes a diffraction grating, wherein a difference between a duty ratio value of a diffraction grating in the end region of the first expansion region and 0.5 is different from a difference between a duty ratio value of a diffraction grating in the central region and 0.5, and wherein a height of the diffraction grating in the end regions of the first expansion region is different from a height of the diffraction grating in the central region. This makes it possible to modulate the diffraction efficiency of the first expansion region to have a desired transition.

(12) A head-up display system of the present disclosure includes: the optical system of any one of (1) to (11); a display part that emits a luminous flux before being expanded by the optical system; and a light-transmitting member that reflects a luminous flux emitted from the optical system, the image as a virtual image being displayed superimposed on a real scene visible through the light-transmitting member.

(13) In the head-up display system of (12), the light-transmitting member is a windshield of a moving object.

The present disclosure is applicable to an optical system and a head-up display system that duplicate and display an image.

### EXPLANATIONS OF LETTERS OR NUMERALS

1 head-up display system
3 vehicles
3a center line
5 windshield
11 display part
13, 13A, 13B, 13C, 13D, 13E, 13F light guide
13a first main surface
13b second main surface
15 controller
17 storage
20 incidence surface
21 coupling region
23 first expansion region
23a first end region
23b central region
23c second end region
25 second expansion region
25p point
27 emission surface
31 diffraction grating
31a grating
Ac visual recognition area
D observer
Iv virtual image
k1, k2, k3, k4, k5, k6, k7, k8, k9, k10, k11, k12, k13, k14 wavenumber vector
L1, L1A, L1B, L2, L2a, L2b, L2c, L3, L3aa, L3ba, L3ca, L3ab, L3bb, L3cb, L3ac, L3bc, L3cc, LA, LAaa, LAbc, LAcb, LAab, LAbb, LAac, LAcc luminous flux

1. An optical system for allowing an observer to visually recognize an image, comprising:
a first expansion region that expands a luminous flux traveling in a first direction by splitting and duplicating it into luminous fluxes traveling in a second direction intersecting the first direction to increase the number of luminous fluxes; and
a second expansion region that expands the luminous fluxes traveling in the second direction by splitting and duplicating them to increase the number of luminous fluxes,
the first expansion region including a central region that contains a center of the first expansion region, and an end region that lies on at least one end side of the first expansion region, the end region having a diffracted light quantity less than half the diffracted light quantity in the central region.

2. The optical system according to claim 1, wherein
the second expansion region lies in the second direction of the central region, and
a region without the second expansion region lies in the second direction of the end region.

3. The optical system according to claim 1, wherein
a length in the first direction of the first expansion region is longer than a length in the first direction of the second expansion region.

4. The optical system according to claim 1, wherein
in a transition of a proportion of a diffracted light quantity along the first direction in the first expansion region,
the proportion of the diffracted light quantity in the central region of the first expansion region overlapping with the second expansion region when viewed from the second direction is within a range of ±10% of a design value.

5. The optical system according to claim 1, wherein
in the end region of the first expansion region, the diffracted light quantity increases from an end of the end region away from the central region of the first expansion region toward the central region.

6. The optical system according to claim 1, wherein
the central region of the first expansion region is a region having a length of ¼ or more and ¾ or less from an end in the first direction, and
the end region is a region having a length of less than ¼ from an end in the first direction.

7. The optical system according to claim 1, comprising:
a coupling region that changes a traveling direction of an incident luminous flux toward the first expansion region, wherein
the end region of the first expansion region is a region closer to the coupling region.

8. The optical system according to claim 1, comprising:
a coupling region that changes a traveling direction of an incident luminous flux toward the first expansion region, wherein
the end region of the first expansion region is a region farther from the coupling region.

9. The optical system according to claim 1, wherein
the first expansion region includes a diffraction grating, and
a height of the diffraction grating in the end regions of the first expansion region is lower than a height of the diffraction grating in the central region.

10. The optical system according to claim 1, wherein
the first expansion region includes a plurality of diffraction gratings, and
a duty ratio Dr1 of the diffraction grating in the end region of the first expansion region and a duty ratio Dr2 of the diffraction grating in the central region have a relationship given by a following conditional expression,
$$\vert Dr 1 - 0.5 \vert > \vert Dr 2 - 0.5 \vert .$$

11. The optical system according to claim 1, wherein
the first expansion region includes a plurality of diffraction gratings,
an absolute value of a difference between a duty ratio value of a diffraction grating in the end region of the first expansion region and 0.5 is different from an absolute value of a difference between a duty ratio value of a diffraction grating in the central region and 0.5, and
a height of the diffraction grating in the end region of the first expansion region is different from a height of the diffraction grating in the central region.

12. A head-up display system comprising:
the optical system of claim 1;
a display part that emits a luminous flux before being expanded by the optical system; and
a light-transmitting member that reflects a luminous flux emitted from the optical system,
the image as a virtual image being displayed superimposed on a real scene visible through the light-transmitting member.

13. The head-up display system according to claim 12, wherein
the light-transmitting member is a windshield of a moving object.

14. The optical system according to claim 1, wherein
the end region of the first expansion region lies on the end side of the first expansion region on which the luminous flux is incident.

15. The optical system according to claim 2, wherein
a length in the first direction of the first expansion region is longer than a length in the first direction of the second expansion region.

16. The optical system according to claim 2, wherein
in a transition of a proportion of a diffracted light quantity along the first direction in the first expansion region,
the proportion of the diffracted light quantity in the central region of the first expansion region overlapping with the second expansion region when viewed from the second direction is within a range of ±10% of a design value.

17. The optical system according to claim 2, wherein
in the end region of the first expansion region, the diffracted light quantity increases from an end of the end region away from the central region of the first expansion region toward the central region.

18. The optical system according to claim 2, wherein
the central region of the first expansion region is a region having a length of ¼ or more and ¾ or less from an end in the first direction, and
the end region is a region having a length of less than ¼ from an end in the first direction.

19. The optical system according to claim 2, comprising:
a coupling region that changes a traveling direction of an incident luminous flux toward the first expansion region, wherein
the end region of the first expansion region is a region closer to the coupling region.

20. The optical system according to claim 2, comprising:
a coupling region that changes a traveling direction of an incident luminous flux toward the first expansion region, wherein
the end region of the first expansion region is a region farther from the coupling region.
